(19) United States
(12) Patent Application Publication
(10) Pub. No.: US 2003/0099793 A1
(43) Pub. Date: May 29, 2003

(54) Plastic films and rolls for in-mold labeling, labels made by printing thereon, and blow molded articles labeled therewith

(76) Inventor: Peter J. Dronzek JR., Thornwood, NY (US)

Correspondence Address: HEDMAN & COSTIGAN, P.C., 1185 Avenue of the Americas, New York, NY, 10036, US

(21) Appl. No.: 10/054,324

(22) Filed: Nov. 12, 2001

(51) Int. Cl. B32B 1/02; B29C 49/24

(52) U.S. Cl. 428/35.7; 428/195; 264/509

(57) ABSTRACT

Polymeric sheets or rolls suitable for printing and forming in-mold labels for plastic containers comprise a multi-layered, co-extruded, polymeric substrate having a container-facing side and an indicia-receiving side, at least one layer being a heat seal layer coextruded on the container-facing side, and at least one heat activatable adhesive layer which is coated on the container-facing side over the coextruded heat seal layer. Such a sheet or roll can be printed with label indicia and then cut into individual labels for affixing to the container as part of the in-molding process. Recyclable containers are provided having firmly adherent, squeeze-release-resistant labels.

### FIELD OF THE INVENTION

This invention relates to polymeric sheets or rolls particularly adapted for use in the in-mold labeling of blow-molded plastic containers. More particularly, the present invention relates to multi-layered, co-extruded, films having a heat activatable adhesive thereon and adapted for printing and use as labels in such in-mold labeling applications.

### BACKGROUND OF THE INVENTION

Plastic containers or bottles are prevalent today in a wide variety of shapes and sizes for holding many different kinds of materials such as light duty liquids (e.g., beverages, such as tea, and household cleansers, such as dishwashing detergent), heavy duty liquids (e.g., laundry detergents), motor oil, vegetable oil, herbicides, etc. Generally, these containers are fabricated from layers or a plurality of layers of plastic, particularly polypropylene, polyethylene and polyesters, particularly poly(ethylene terephthalate), by means of blow molding or injection molding.

Generally also, such containers are provided with a label which designates the trade name of the product and may contain other information as well. In some instances, the label is merely attached to the container after molding by means of adhesive or the like. However, the label may also be attached to the container during the container molding process. This technology by which the label is associated with the container during the molding operation is generally referred to as an in-mold label process.

Many devices are known for performing in-mold labeling of a plastic container. For example, in U.S. Pat. No. 4,837,075 issued to Dudley in 1989, there is shown a coextruded plastic film label for in-mold labeling comprising a heat activatable ethylene copolymer adhesive layer and a surface printable layer comprising polystyrene with optional intermediate layers to provide interlayer adhesion and recyclability of reground labels. The label has preferably a thickness in the range of from about 0.002 to 0.005 inches (0.05 to 0.127 mm).

In published European Patent Application No. 0,281,701 in the name of Court et al in 1988, there is disclosed an in-mold label formed from a thin sheet of multicellular thermoplastic film composed of a biaxially extruded opaque, non-transparent polyethylene/polystyrene copolymer coated with a heat activatable adhesive layer for use with a blow molded plastic container. The in-mold label is said to resist curling, wrinkling and crazing, to have thermodynamic properties similar to those of the plastic of the container, and may be recycled along with the container.

In International Patent Application No. WO 93/09925 in the names of Dronzek, Jr. and Sedran, published May 27, 1993, there are disclosed polymeric sheets or rolls suitable for printing and forming in-mold labels for plastic containers comprise a polymeric transparent, translucent or contact clear substrate having a thickness in the range of 0.002 to 0.008 inches which is coated on the container-facing side with a heat activatable adhesive. Such a sheet or roll can be printed with label indicia on the exposed face or reverse printed on the face covered by the adhesive and then cut into individual labels for affixing to the container as part of the in-molding process. Recyclable containers are provided having firmly adherent, squeeze-release resistant labels and the indicia in preferred embodiments are protected from spillage because they are viewable through the labels themselves.

It has now been discovered that multi-layered polymeric films having judiciously selected characteristics of thickness and coefficient of expansion and contraction and provided with a heat activatable adhesive coating over a co-extruded seal layer have improved and surprising characteristics of adhesion to in-mold blown plastic containers with resistance to damage from cracking, tearing, creasing, wrinkling or shrinking due to physical abuse and flexing of the plastic container material.

Accordingly, a principal object of the present invention is to provide printable polymeric sheets or rolls for labels for in-mold use without the problems discussed above. It is a further object of the invention to provide a method for in-mold labeling of hollow plastic containers using printed labels made from such sheets. It is still another object of the invention to provide articles labeled with printed labels which have the unexpectedly superior properties described above.

These and other objects of the invention will become apparent from the present specification.

### DESCRIPTION OF THE DRAWINGS

In the drawings:

FIG. 1 is a schematic illustration of an heat-activatable adhesive-coating layer over a coextruded melt heat seal-layer over a substrate layer substrate in accordance with the present invention.

FIG. 2 is a schematic illustration of an uncoated, coextruded melt heat seal-layer over a substrate layer substrate in accordance with the prior art (Dudley, U.S. Pat. No. 4,837,075).

FIG. 3 is a schematic illustration of an heat-activatable adhesive-coating layer directly over a substrate layer substrate in accordance with the prior art (Court et al EP 0,281,701).

FIG. 4 is a flow diagram of an apparatus useful to produce adhesive-coated multi-layered, indicia-printed label stock suitable for in-mold labeling in accordance with the present invention.

### SUMMARY OF THE INVENTION

According to this invention, in one of its major aspects, there are provided polymeric sheets or rolls particularly adapted for use in the in-mold labeling of blow-molded plastic containers, the sheets or rolls comprising a multi-layered, co-extruded, polymeric substrate having a container-facing side and an indicia-receiving side, at least one layer being a heat sealable layer coextruded on the container-facing side of said multi-layered substrate, and at least one heat activatable adhesive layer which is coated on all or a patterned portion of the container-facing side over the co-extruded heat sealable layer, the adhesive being characterized by the ability to form a bond with the co-extruded seal layer and the plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to the plastic container with resistance to damage from cracking, tearing, creasing, wrinkling or shrinking due to physical abuse and flexing of the plastic container material.

In preferred features, the invention contemplates a polymeric sheet or roll as defined above which also includes: those wherein the print receiving side of the multilayered polymeric substrate comprises at least one co-extruded layer formed from a polymer or a mixture of polymers, the layer being surface printable or capable of being rendered surface printable, the substrate having an overall thickness between 0.002 and 0.008 inches, and having a coefficient of thermal expansion or contraction under the conditions which the container sees the same or substantially the same as that of the plastic from which said container is made. Also provided are such sheets or rolls wherein the layer of substrate comprises a virgin or recycled polyester; a polymeric sheet or roll as defined above wherein the layer of substrate comprises a virgin or recycled olefin homopolymer or copolymer or a blend thereof; a polymeric sheet or roll as defined above further comprising printed indicia on said print-receiving area of the substrate. Also contemplated is a polymeric sheet or roll as above defined wherein said printed indicia is provided with a varnish or lacquer for sealing the printed image; a polymeric sheet or roll as first above defined wherein the heat activated adhesive layer is a combination of a coated layer on top of a coextruded sealable layer; a polymeric sheet or roll as defined above wherein the heat activated adhesive layer comprises an ethylene/vinyl acetate copolymer. The invention also provides a polymeric sheet or roll as defined above wherein the print-receiving face of the substrate has been treated to enhance ink anchorage by application of a primer, by flame treatment, by corona-treatment or by chemical treatment.

In another major aspect, the invention provides in-mold labels for plastic containers, the labels comprising: individual labels cut from the sheets and rolls as defined above, printed and coated.

Still another major aspect of the invention provides plastic containers, especially those comprised of single or multilayers of polypropylene, polyethylene or polyester, of the type produced by blow molding, including improved in-mold labels adhered to the outer surface of the containers, the labels comprising those as defined immediately above.

In a further major aspect, the present invention contemplates: a method of producing an in-mold plastic container comprising:

(a) providing a polymeric sheet or roll comprising a multi-layered, co-extruded, polymeric substrate having a container-facing side and an indicia-receiving side, at least one layer being a heat seal layer coextruded on the container-facing side of said multi-layered substrate, and at least one heat activatable adhesive layer which is coated on all or a patterned portion of the container-facing side over the heat seal layer, said adhesive being characterized by the ability to form a bond with said co-extruded heat seal layer and said plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to a plastic container with resistance to damage from cracking, tearing, creasing, wrinkling or shrinking due to physical abuse and flexing of the plastic container material, wherein said print receiving side of said multilayered polymeric substrate comprises at least one co-extruded layer formed from a polymer or a mixture of polymers, said layer being surface printable or capable of being rendered surface printable, said substrate having an overall thickness between 0.002 and 0.008 inches, and having a coefficient of thermal expansion or contraction under the conditions which a container sees the same or substantially the same as that of the plastic from which said container is made, said polymeric sheet being regrind compatible with the plastic containers which are to be blow molded around labels made from it;

(b) printing indicia on said print-receiving area of said substrate;

(c) cutting said sheet into a plurality of individual labels, each label bearing printed indicia;

(d) positioning one of said labels in a mold;

(e) blow molding a plastic container within said mold such that said label adheres to the outer surface of the blow molded container; and

(f) removing said container from the mold.

### DETAILED DESCRIPTION OF THE INVENTION

The terms “virgin” and “recycled” when used herein and in the appended claims mean, respectively, new resin and reground resin.

The term “regrind compatible” when used herein and in the appended claims means that containers with in-mold labels can be reground and molded after being mixed with virgin material. Regrind compatibility is determined by regrinding, mixing and molding.

The terms “primer”, “flame-treatment”, “corona treatment”, and “chemical treatment” when used herein and in the appended claims mean, respectively, a deposited coating for promoting adhesion generally comprising a filled or unfilled polymer, surface activation by carefully exposing to a bank of flames, without burning or distortion, exposure to high voltage direct current to microscopically etch the surface, and carefully etching the surface with chemicals known to be effective for this purpose.

Referring to FIG. 1, a support structure of this invention comprising a multi-layer laminate 10 is shown. The laminate 10 includes a support structure comprising, as essential elements 16, 14, and 12, which are, reading from the top down: coated heat-activated adhesive, such as a high molecular weight ethylene interpolymer layer 16, coextruded melt heat seal, such as an ethylene/vinyl acetate copolymer layer 14, and resin film layer, such as polypropylene or high density polyethylene coextruded layer 12.

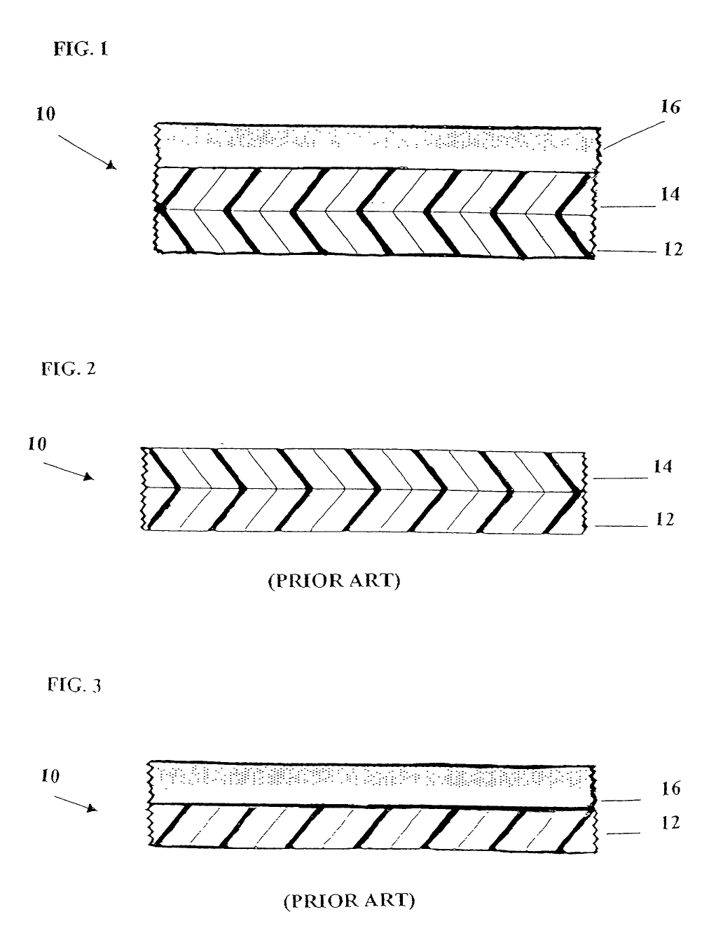

Referring to FIG. 2, another support structure is shown, this time in accordance with the prior art (Dudley, U.S. Pat. No. 4,837,075). The laminate 10 includes a support structure comprising, as essential elements 14 and 12, which are, reading from the top down: coextruded melt heat seal layer, such as ethylene/vinyl acetate copolymer 14, and substrate film, such as high density polyethylene coextruded layer 12.

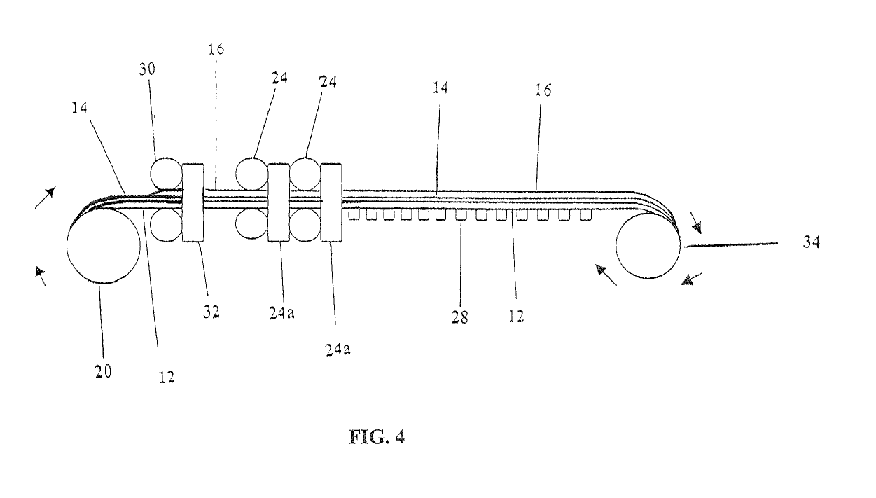

Referring to FIG. 3, another support structure is shown, this time in accordance with the prior art (Court et al, EP 0,281,701). The laminate 10 includes a support structure comprising, as essential elements 16 and 12, which are, reading from the top down: coated heat-activated adhesive layer 16, and resin film layer, such as polyethylene/polystyrene layer 12.

Referring to FIG. 4, one preferred process to make a laminated support structure of the invention is illustrated in flow diagram form. Multi-layer plastic film, e.g., oriented polypropylene or polyethylene under a co-extruded melt heat seal layer 12 is supplied by roll 20 and is coated at station 30 with a solvent or an aqueous adhesive layer 16 over the coextruded seal layer. Next the coated substrate is passed to one, but preferably more, dryer/printer stations 21 and indicia 28 are printed thereon and, preferably provided with a protective over-coat (not shown). At the end of the line the support structure is wound up on roll 34.

Further processing is usually carried out by the end-user in ways well known to those skilled in this art. For example, large rolls can be slit into smaller rolls, or cut into stacks of sheets, and the smaller rolls or sheets can be fed to die-cutting machines to cut labels to suitable size for labeling.

The labels of the invention comprise a substrate which has characteristics substantially similar to the plastic container with which the label is to be used with special reference to the polymers used. This prevents loosening of the label, especially at its edges after the in-mold processing and facilitates recycling.

The substrate film can or cannot be oriented, depending on how it is made. As is well known, cast film can or cannot be oriented, but is usually oriented to a minor degree in the machine direction (MD). Blown film is usually oriented due to the manufacturing process, but is not usually sold as oriented because it is an unbalanced orientation. Oriented film is usually oriented to a major degree, and orientation can be monoaxial or biaxial. Although any such film can be used in the present invention, it is preferred to use at least one layer of monoaxially or biaxially oriented film as the substrate.

Orientation gives the labels sufficient stiffness and facilitates their use in label transfer devices in automated molding equipment. The substrate should have “a coefficient of thermal expansion or contraction under the conditions which the container sees the same or substantially the same as that of the plastic from which said container is made.” Some variability is permissible, and the characteristic seems to be a factor in preventing lifting of the edges of the blow molded containers bearing the in-mold labels of the invention. Coefficient of thermal expansion or contraction is measured by standard methods, such as by ASTM Method D696, which expresses the values in units of 10⁻⁶ in/in/°C., or in values of %/°C. from which the permissible variations mentioned hereinabove are measured. However, the best test is a practical one: make a test container and subject it to a heat and cooling cycling in a controlled temperature oven. Those combinations of label materials and bottle plastics free of edge lifting are suitable.

A heat activatable adhesive is applied to a surface of the substrate which will come into contact with the container. Selected inkwork comprising printed indicia is printed on the opposite surface of the substrate. The label is then positioned in a blow mold prior to container formation. As the container is formed, the adhesive and coextruded seal layer are activated by the heat of the mold and its contents and adheres the label to an outer surface of the container with the adhesive and seal layer melt fusing together.

The preferred embodiments of the labels of the present invention are fabricated from extruded, cast or blown films of polyolefin, e.g., polyethylene or polypropylene or polyester and these essentially are provided with at least one co-extruded seal layer and may optionally be provided with a print enhancing coating such as those well known to those skilled in this art. The films are provided in sheets or rolls which may be printed with conventional label indicia on conventional printing equipment and furthermore can be die cut and applied to plastic containers using conventional in-mold equipment. Although for purposes of exemplary showing, the present invention is described and illustrated in connection with a polyethylene container, it will be understood that in-mold labeling may also be applied in the formation of propylene multi-layer bottles, polyethylene terephthalate bottles and other types of plastic containers formed by blow molding.

The preferred construction of the improved in-mold labels of the present invention uses a thermoplastic film comprised of a polypropylene polymer in at least one co-extruded layer. Such films are marketed under the name “PolySyn® (M501 Grade)” by Mark Products Corporation, Wood Dale, Ill. 60191, U.S.A. Other sources of such films are marketed under the name “Kimdura® ITE 105” Kimberly-Clark Corp., Roswell, Ga. 30076 U.S.A., and others by Avery Dennison Engineered Films Division, Concord, Ohio 44077 U.S.A. In order to enhance the printing qualities of the thermoplastic film it may be provided with, for example, a filler, e.g., filled with clay/calcium carbonate, silica and/or china clay, etc., or an unfilled primer coating, such as an acrylic type resin. Typically such primers are available commercially from sources well known to those skilled in this art. For example, polyester and acrylic primers are marketed under the name “ADCOTE®” by Rohm & Haas, Philadelphia, Pa., U.S.A. The coating helps insure that the surface of the film will accept high quality printing and may also improve the abrasion and scuff resistant qualities of the finished label.

The physical properties of the aforementioned oriented heat seal coextruded thermoplastic polypropylene film (PolySyn® (M501 Grade), are set forth in Table 1:

TABLE 1

| | | REFERENCE | | | |
|---|---|---|---|---|---|
| ITEM | Unit | DATA | | | TEST METHOD |
| THICKNESS | μ | 60 | 80 | 100 | TAPPI T-411 |
| SPECIFIC GRAVITY | g/m² | 0.76 | 0.76 | 0.76 | ASTM-D792 |
| OPTICAL DENSITY | % | 0.80 | 0.85 | 0.95 | ASTM-D1893 |
| GLOSS, W1 | % | 25 | 25 | 27 | TAPPI T-480 |
| BRIGHTNESS, W1 | % | 95 | 95 | 95 | TAPPI T-595 |
| OPACITY | % | 84 | 86 | 90 | TAPPI T-425 |
| ROUGHNESS, W1 | μ | 1.4 | 1.4 | 1.00 | TAPPI T-555 |
| SURFACE | Ω | 9 × 10¹¹⁻¹⁴ | 9 × 10¹¹⁻¹⁴ | 9 × 10¹¹⁻¹⁴ | ASTM D-257 |
| RESISTIVITY, W1 | | | | | |
| HEAT SEAL | ° C. | 130 | 130 | 130 | |
| TEMPERATURE | | | | | |
| ELONGATION, | % | 133/47 | 132/54 | 120/60 | ASTM D-882 |
| MD/CD | | | | | |
| SURFACE TENSION, | Dyne/cm | 40/38 | 40/38 | 40/38 | ASTM-D2578 |
| W1/W2 | | | | | |
| THERMAL | % | 0.67/0.11 | 1.22/0.66 | 1.28/0.36 | ASTM-D2732 |
| SHRINKAGE, MD/CD | | | | | |

MD = machine direction;
CD = (cross (transverse) direction
W1 = surface;
W2 = back

The heat activated adhesive coating layer is applied to such label sheets in a conventional manner. The use of such coatings for in-mold labels is reviewed in detail by D. H. Wiesman in Tappi Journal, Vol 69, No. 6, June 1986. A preferred adhesive comprises an organic polymeric resin such as an ethylene/vinyl acetate copolymer gel or dispersion. A suitable source of such adhesives is Rohm & Haas which sells such products under the name “ADCOTE®” 31DW1974 (Solvent-based) and 37P295 (Water-based). Also suitable is a warm melt adhesive designated Product No. S11723 and sold by Selective Coatings & Inks, Inc., Farmingdale, N.J., U.S.A. Before, or after, applying the adhesive, the film is printed with suitable label indicia in a conventional manner. The adhesive is preferably applied so as to produce a smooth, continuous coating. It can also be applied by a gravure coating process, which may produce a patterned coating providing channels for air to evacuate from the mold. It has been found that the printing quality of the present thermoplastic film labels is equivalent to the printing quality of conventional paper labels. Finally, individual labels may be die cut from the sheets or rolls in the conventional manner.

With respect to printing, various methods are used in this art to apply information or decorations to plastics, Indeed, most of the processes for printing on paper also apply to printing on plastics. The most common printing techniques used are gravure, lithographic and flexographic. To avoid unnecessarily detailed description, reference is made to Modern Plastics Encyclopedia, Mid-October Issue, 1989, “Printing” by Hans Deamer, pages 381-383.

Selection of the printing inks for use, and formation of print-enhancing surfaces and the production of images or indicia are well within the skill of workers in this field. Also, it is easily obvious to the artisan to produce the films of this invention with printed indicia on any print-receiving surface and to carry out the printing operation in the stages set forth in the description above. The inclusion of varnishes or lacquers for sealing the printed image and corona-treating to promote adhesive bonding is also conventional in this art.

The in-mold labels of the present invention may be utilized on conventional in-mold labeling apparatus in the same manner as conventional paper labels. See, for example, the article in Tappi Journal, cited above.

To save unnecessarily detailed description, devices for performing in-mold labeling on a container, which are well known, are the subject matters of U.S. Pat. No. 3,759,643 to Langecker, 1973, and U.S. Pat. No. 4,479,644 to Bartlmee et al, 1984. In general, all such apparatus use a blow mold having a cavity for containing a hollow body, and a member which is movable toward the cavity. The member includes a section for carrying a label to be applied the hollow body during movement of the member toward the cavity. Ventilation openings are provided in the mold for venting any air between the hollow body and label. Variations in the apparatus that may be employed include using rotating mold units and oscillating means for picking up individual labels and depositing them in the rotating molds at appropriate intervals to automate the process.

To demonstrate the specification-taught advantages of the present invention the following comparative test data were obtained:

Substrates tested:

M501—NANYA Plastics 3.2 mil white opaque polypropylene with coextruded seal layer.

ITE-105—Kimberly-Clark (KC manufactured by YUPO Corp.) 4.1 mil white oriented polypropylene with coextruded seal layer.

Adhesives used:

Aqueous—ADCOTE 37P295 dispersion from Rohm and Haas.

Solvent—ADCOTE 33DW2086 gel lacquer from Rohm and Haas.

Laboratory equipment:

Sentinel heat seal unit with heated platten and non-stick surface.

#3 and #6 wire wound metering rods.

Corona treater.

Other materials:

Strips of commercially blow molded DIAL® containers never used or contaminated.

Test procedure:

Corona-treat the seal layer side of both the NANYA and Kimberly-Clark substrates.

Apply the aqueous and solvent adhesives to the corona-treated side of each substrate using the #6 metering rod which produces a coated substrate with a deposition of 2.5-3.0 #/3000 sq. ft. Ream.

Note: the gel lacquer and substrate were warmed to 125° F. to make the solvent adhesive fluid enough for a draw down.

Apply the aqueous adhesive using the #3 rod to the substrates.

Seal all samples plus control samples with no coated adhesive to strips of the cut bottles using the lab sealer with the strip oriented so the non labeled surface of the strip is in contact with the heat source and the labeled side of the strip is in contact with the adhesive coated side of the substrate. This simulates the blow molding process where the heat flows from the bottle substrate to the sealable side of the label substrate, not through the label substrate. The bottle strip fuses with the sealable side of the label.

Seal conditions are 225° F. platten temperature, 30 psi and 5 second dwell.

Evaluate the results in terms of peel adhesion in grams per inch of width. FT denotes film tear. * denotes prior art.

| Example | Composite | Peel Strength, range |
|---|---|---|
| 1A* | NANYA | 150-180 |
| 1B* | KC | 200-225 |
| 1 | Solvent NANYA (6 rod) | 300-325 |
| 2 | Solvent KC (6 rod) | 325-350 |
| 3 | Aqueous NANYA (6 rod) | 275-FT |
| 4 | Aqueous NANYA (3 rod) | 280-FT |
| 5 | Aqueous KC (6 rod) | 265-FT |
| 6 | Aqueous KC (3 rod) | 280-FT |

The data shows that bond strengths are improved through the addition of a coated layer over the sealable coextruded layer (Examples 1-6). Even using a lower deposition as produced with the #3 laboratory rod Examples 4-6, the desired improvement is shown.

The patents, applications, publications and test methods mentioned above are incorporated herein by reference.

Many variations of the present invention will suggest themselves to those skilled in the art in light of the above detailed description. For example, instead of virgin oriented polypropylene as the substrate film, virgin poly(ethylene terephthalate), polyamide, polyethylene, polycarbonate, fluoropolymers and polyimide films can be used. Instead of 0.007 inch polyester film, 0.004 inch polyester film can be used. Instead of ethylene/vinyl acetate as the heat activated adhesive layer, low density polyethylene can be used. Instead of an acrylic printing enhancing coating, another coating, such as a polyester or urethane resin containing finely divided clay or silica, can be spread on the print receiving face of the polymeric sheet or roll. Instead of a polyethylene container, a polypropylene container or a polyester container, the labels can be applied to containers made by blow molding single or multi-layers of barex, cellulose acetate, cellulose acetate butyrate, cellulose acetate propionate, ionomer resin, K-resin, polystyrene and poly(vinyl chloride). Polypropylene labels can be put on polyethylene containers and polyethylene labels can be put on polypropylene containers.

All such obvious modifications are within the full intended scope of the appended claims.

1. A polymeric sheet or roll particularly adapted for use in the in-mold labeling of blow-molded plastic containers, said sheet or roll comprising a multi-layered, co-extruded, polymeric substrate having a container-facing side and an indicia-receiving side, at least one layer being a heat seal layer coextruded on the container-facing side of said multi-layered substrate, and at least one heat activatable adhesive layer which is coated on all or a patterned portion of the container-facing side over the co-extruded heat seal layer, said adhesive being characterized by the ability to form a bond with said co-extruded heat seal layer and said plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to the plastic container with resistance to damage from cracking, tearing, creasing, wrinkling or shrinking due to physical abuse and flexing of the plastic container material.

2. A polymeric sheet or roll as defined in claim 1 said print receiving side of said multilayered polymeric substrate comprises at least one co-extruded layer formed from a polymer or a mixture of polymers, said layer being surface printable or capable of being rendered surface printable, said substrate having an overall thickness between 0.002 and 0.008 inches, and having a coefficient of thermal expansion or contraction under the conditions which the container sees the same or substantially the same as that of the plastic from which said container is made.

3. A polymeric sheet or roll as defined in claim 1 wherein said polymeric substrate comprises at least one coextruded layer of virgin or recycled polyester or blends of the foregoing.

4. A polymeric sheet or roll as defined in claim 1 wherein said polymeric substrate comprises at least one coextruded layer of virgin or recycled olefin homopolymer or copolymer or blends of the foregoing.

5. A polymeric sheet or roll as defined in claim 2 further comprising printed indicia on said print-receiving area of said substrate.

6. A polymeric sheet or roll as defined in claim 5 wherein said indicia are over-coated with a protective varnish or lacquer whereby after affixing labels made from said sheet or roll to a plastic container during the blow molding process there will be provided protection for the printed image from the contents of the container if spilled, from the environment and from abrasion when the container is processed, shipped or used.

7. A polymeric sheet or roll as defined in claim 1 wherein said heat activated layer is the combination of the coated layer and the coextruded sealable layer.

8. A polymeric sheet or roll as defined in claim 7 wherein said heat activated adhesive layer comprises an ethylene/vinyl acetate copolymer.

9. A polymeric sheet or roll as defined in claim 2 wherein the print-receiving face of said substrate has been treated to enhance ink anchorage by application of a primer, by flame-treatment, by corona-treatment or by chemical treatment.

10. A polymeric sheet or roll as defined in claim 1 wherein the seal layer has been corona-treated to promote wetting of the adhesive coating.

11. A flexible and deformable label for deformable plastic containers, said label comprising a multi-layered, co-extruded, polymeric substrate having a container-facing side and an indicia-receiving side, at least one layer being a heat seal layer coextruded on the container-facing side of said multi-layered substrate, and at least one heat activatable adhesive layer which is coated on all or a patterned portion of the container-facing side over the heat seal layer, said adhesive being characterized by the ability to form a bond with said co-extruded heat seal layer and said plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to the plastic container with resistance to damage from cracking, tearing, creasing, wrinkling or shrinking due to physical abuse and flexing of the plastic container material, and said label further includes printed indicia on said print-receiving area of said substrate.

12. A label as defined in claim 11 wherein said layer of substrate comprises a virgin or recycled polyester or blends thereof.

13. A label as defined in claim 11 wherein said layer of substrate comprises a virgin or recycled olefin homopolymer or copolymer or a blend of any of the foregoing.

14. A label as defined in claim 11 wherein said printed indicia is provided with a varnish or lacquer for sealing the printed image.

15. A label as defined in claim 11 wherein said heat activated adhesive layer is the combination of the coated layer and the coextruded sealable layer.

16. A label as defined in claim 15 wherein said heat activated adhesive layer comprises ethylene/vinyl acetate copolymer.

17. A label as defined in claim 11 wherein the print-receiving face of said substrate has been treated to enhance ink anchorage by application of a primer, by flame-treatment, by corona-treatment or by chemical treatment.

18. A label as defined in claim 11 wherein the seal layer has been corona-treated to promote wetting of the adhesive coating.

19. In a plastic container of the type produced by blow molding, the improvement in combination therewith comprising an in-mold label adhered to the outer surface of said container, said label comprising a multi-layered, co-extruded polymeric substrate having a container-facing side and an indicia-receiving side, at least one layer being a heat seal layer coextruded on the container-facing side of said multi-layered substrate, and at least one heat activatable adhesive layer which is coated on all or a patterned portion of the container-facing side over the heat seal layer, said adhesive being characterized by the ability to form a bond with said co-extruded heat seal layer and said plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to the plastic container with resistance to damage from cracking, tearing, creasing, wrinkling or shrinking due to physical abuse and flexing of the plastic container material, and said label further includes printed indicia on said print-receiving area of said substrate.

20. A plastic container as defined in claim 19 wherein said plastic container comprises a multilayer of polypropylene, polyethylene, polyester or a mixture of any of such plastics.

21. A plastic container as defined in claim 19 wherein said layer of substrate comprises a virgin or recycled polyester or blends thereof.

22. A plastic container as defined in claim 19 wherein said layer of substrate comprises a virgin or recycled olefin homopolymer or copolymer or a blend of any of the foregoing.

23. A plastic container as defined in claim 19 wherein said printed indicia is provided with a lacquer or varnish for sealing the printed image.

24. A plastic container as defined in claim 19 wherein said heat activated adhesive layer is the combination of the coated layer and the coextruded sealable layer.

25. A plastic container as defined in claim 24 wherein said heat activated adhesive layer comprises an ethylene/vinyl acetate copolymer.

26. A plastic container as defined in claim 19 wherein the print-receiving face of said substrate has been treated to enhance ink anchorage by application of a primer, by flame-treatment, by corona-treatment or by chemical treatment.

27. A plastic container as defined in claim 19 wherein the seal layer has been corona-treated to promote wetting of the adhesive coating.

28. A method of producing an in-mold-labeled plastic container, said method comprising:
(a) providing a polymeric sheet or roll comprising a multi-layered, co-extruded, polymeric substrate having a container-facing side and an indicia-receiving side, at least one layer being a heat seal layer coextruded on the container-facing side of said multi-layered substrate, and at least one heat activatable adhesive layer which is coated on all or a patterned portion of the container-facing side over the heat seal layer, said adhesive being characterized by the ability to form a bond with said co-extruded heat seal layer and said plastic container such that the strength of the substrate-adhesive interface and the plastic container-adhesive interface and the cohesive strength of the adhesive itself are all greater than the forces required for deformation and recovery of the film itself, whereby labels made from said polymeric sheet or roll have improved and surprising characteristics of adhesion to a plastic container with resistance to damage from cracking, tearing, creasing, wrinkling or shrinking due to physical abuse and flexing of the plastic container material, wherein said print receiving side of said multilayered polymeric substrate comprises at least one co-extruded layer formed from a polymer or a mixture of polymers, said layer being surface printable or capable of being rendered surface printable, said substrate having an overall thickness between 0.002 and 0.008 inches, and having a coefficient of thermal expansion or contraction under the conditions which a container sees the same or substantially the same as that of the plastic from which said container is made, said polymeric sheet being regrind compatible with the plastic containers which are to be blow molded around labels made from it;
(b) printing indicia on said print-receiving area of said substrate;
(c) cutting said sheet into a plurality of individual labels, each label bearing printed indicia;
(d) positioning one of said labels in a mold;
(e) blow molding a plastic container within said mold such that said label adheres to the outer surface of the blow molded container; and
(f) removing said container from the mold.

29. A method as defined in claim 28 wherein said plastic container comprises a multilayer of polypropylene, polyethylene, polyester or a mixture of any of such plastics.

30. A method as defined in claim 28 wherein said layer of substrate comprises a virgin or recycled polyester or blends thereof.

31. A method as defined in claim 28 wherein said layer of substrate comprises a virgin or recycled olefin homopolymer or copolymer or a blend of any of the foregoing.

32. A method as defined in claim 28 including the step of providing said printed indicia with a varnish or lacquer for sealing the printed image.

33. A method as defined in claim 28 wherein said heat activated adhesive layer is the combination of the coated layer and the coextruded sealable layer.

34. A method as defined in claim 28 wherein said heat activated adhesive layer comprises an ethylene/vinyl acetate copolymer.

35. A method as defined in claim 28 including the step of treating the print-receiving face of said substrate to enhance ink anchorage by applying a primer, by flame-treating, by corona-treating or by chemical-treating.

36. A method as defined in claim 28 including the step of corona-treating the seal layer to promote wetting of the adhesive coating.
